(19) United States
(12) Patent Application Publication
(10) Pub. No.: US 2018/0262401 A1
(43) Pub. Date: Sep. 13, 2018

(54) Systems and Methods for Selection of Parent Nodes in a Network

(71) Applicant: Nebulae LLC, Marshall, TX (US)

(72) Inventors: Meet Shah, Anand (IN); Utpal Solanki, Anand (IN); Tejas Vaghela, Anand (IN)

(73) Assignee: Nebulae LLC, Marshall, TX (US)

(21) Appl. No.: 15/379,358

(22) Filed: Dec. 14, 2016

(30) Foreign Application Priority Data
Dec. 17, 2015 (IN) 4729/MUM/2015

(51) Int. Cl. H04L 12/24; H04W 4/38

(52) U.S. Cl. CPC H04L 41/12; H04W 88/16; H04W 4/38

(57) ABSTRACT

Low-powered wireless communication devices are used for control and monitoring in a wide range of applications, including, but not limited to, home automation, agriculture, energy management, infrastructure monitoring, and defense systems. RPL (Routing Protocol for Low Power Lossy Networks) is used for networking between routers and their interconnections in wireless communication environments that are characterized by high loss rates, low data rates, and instability. The present invention improves the performance of RPL by adding a weighted average Link Quality Indicator to a Rank determination methodology for selecting parent nodes in establishing and maintaining an RPL network.

The following specification particularly describes the nature of this invention and the manner in which it is to be performed.

### FIELD OF THE INVENTION

The present invention relates to systems and methods for communications among devices in a wireless network of interconnected devices such as nodes and gateways including the Internet of Things (IoT), and more particularly to the use of RPL (Routing Protocol for Low Power Lossy Networks), which is used for networking between routers and their interconnections in environments that are characterized by high loss rates, low data rates, and instability, and in particular for selection of parent nodes in an RPL-type network.

### DESCRIPTION OF THE RELATED ART

RPL is a routing protocol for low power and lossy networks that specifies how to construct a Destination Oriented Directed Acyclic Graph (DODAG) to connect each node of a network of devices to a gateway. There generally are three types of Internet Control Message Protocol version 6 (ICMPv6) messages in use in RPL: DODAG Information Object (DIO), Destination Advertisement Object (DAO), and DODAG Information Solicitation (DIS).

The process of building the DODAG begins by creating a DAG root. The DAG root then starts broadcasting DIO messages. Neighbors of the DAG root receive the DIO, validate the information in the DIO, and decide whether or not to join the DAG. If they join the DAG, then the neighbors update the information in the DIO and broadcast it. Through continuation of this process by all reachable nodes, the DODAG will be formed. This process is called the upward path formation.

To form the downward path, when a node receives the DIO from its parent node, it sends back the DAO message. Upon receiving the DAO response, the parent creates or updates the path for that node in the route table. The parent node then forwards this message to its parent. The DAO will be forwarded until it reaches the DAG root.

In traditional DODAG, the parent selection is done by Rank comparison. A node receives DIO messages from many neighbors, compares the Rank of all the neighbors from whom DIO messages were received, and selects the best parent based on Rank comparison. Rank calculation is performed using various metrics, such as ETX (Expected Transmission Count), hop count, estimated delay, etc. Currently, there are two Objective Functions implemented for RPL: OFO (Objective Function zero) and MRHOF (Minimum Rank with Hysteresis Objective Function). OFO is based on the minimum hop count metrics and MRHOF is based on the minimum path ETX.

Traditionally, a node's Rank defines the node's individual position relative to other nodes with respect to a DODAG root. Generally, Rank increases in the Down direction and decreases in the Up direction. The exact way Rank is computed depends on the DAG's Objective Function (OF). The Rank also may track a simple topological distance, or it may be calculated as a function of link metrics, or it may consider other properties such as constraints.

Also, traditionally a node's Rank=Parent's Rank+MIN_HOP_RANK_INCREMENT. For example: If a parent's Rank is 256 and MIN_HOP_RANK_INCREMENT is 256, then, the node's Rank=256+256=512.

In real network environments, there can be instabilities in RPL, particularly at the boundaries of the network. Such instabilities lead to undesirable operations in networks of interconnected devices such as nodes and gateways, including in IoT networks.

### SUMMARY OF THE INVENTION

The present invention provides systems and methods utilizing a modified algorithm that improves network performance by reducing the number of parent switches. In the preferred embodiment of the present invention, the mechanism for parent selection is improved by using the Link Quality Indicator (LQI) in addition to using two standard Objective Functions for RPL.

### BRIEF DESCRIPTION OF THE DRAWINGS

The advantages of the present invention will become more apparent by describing in detail the preferred embodiments with reference to the attached drawings in which:

FIG. 1A a diagram illustrated an IoT type network with cloud/Internet connectivity and controlling capability in accordance with an embodiment of the present invention.

FIG. 1B is a diagram illustrating a Gateway in accordance with an embodiment of the present invention.

FIG. 1C is a diagram illustrating a Node in accordance with an embodiment of the present invention.

FIG. 2 is a diagram of the parent selection process.

FIG. 3 is a description of the ranking process, based on the Link Quality Indicator (LQI).

### DETAILED DESCRIPTION OF THE PREFERRED EMBODIMENTS

The present invention will be described in greater detail with reference to certain preferred and alternative embodiments. As described below, refinements and substitutions of the various embodiments are possible based on the principles and teachings herein.

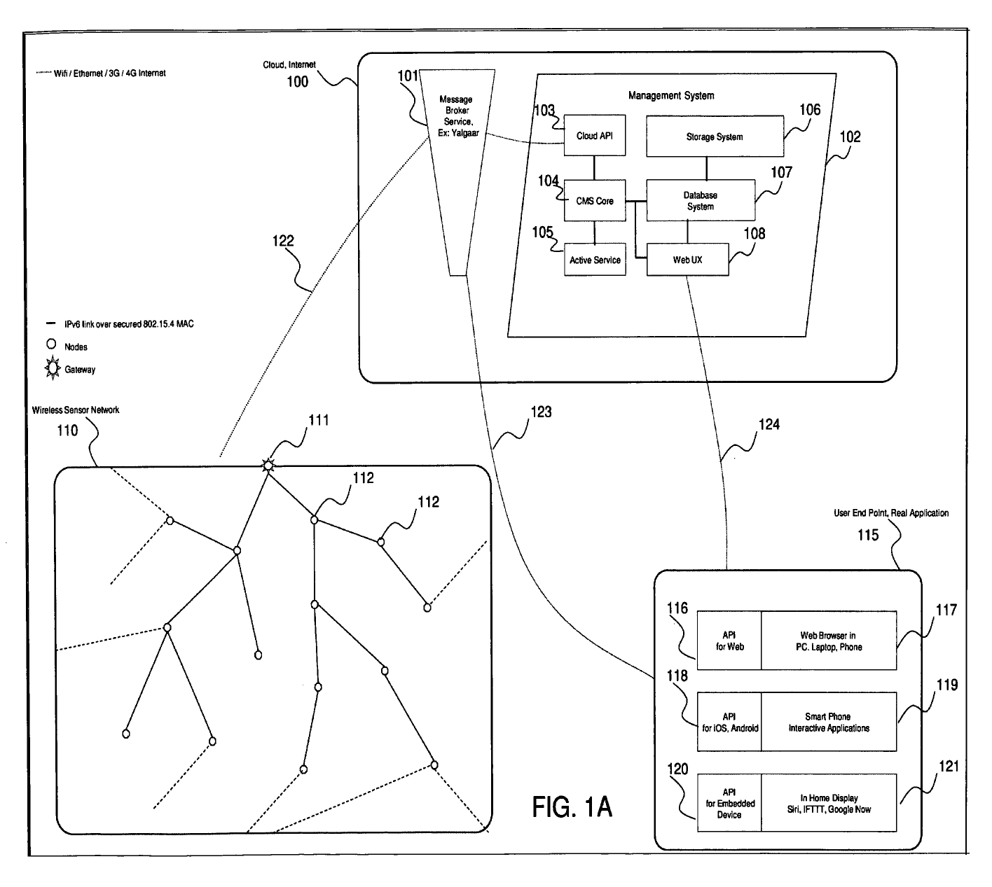

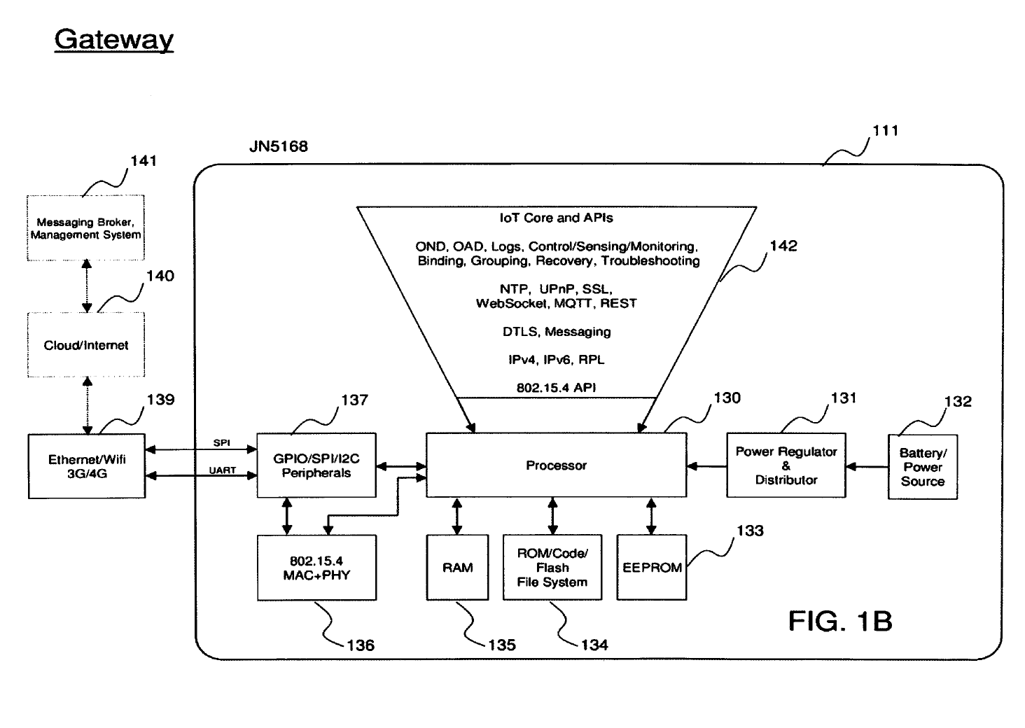

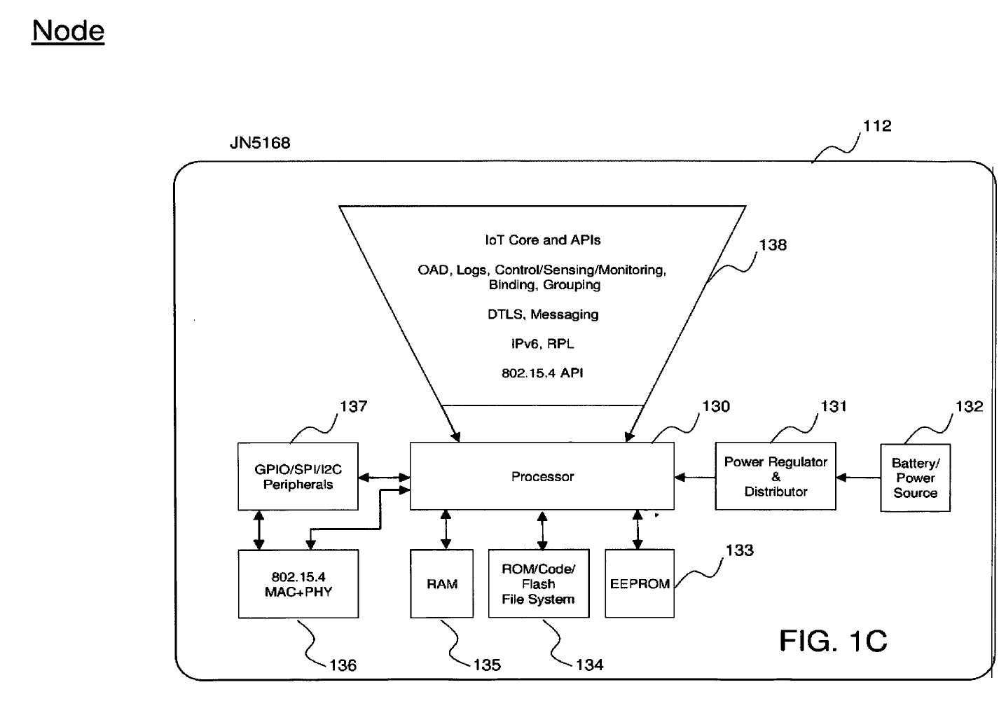

FIG. 1A illustrates an exemplary IoT network architecture in accordance with an embodiment of the present invention. Internet or cloud system 100 is connected to Wireless Sensor Network (WSN) 110 via network connection 122. Cloud system 100 as illustrated includes management system 102 (sometimes called a content management system or CMS) receiving communications from network connection 122 via message broker service 101. What is important is that cloud system 100 be able to receive and send data to WSN 100, which preferably are in the form of compact messages via a message broker service 101 (or other similar data/message communication service or capability included in cloud system 100). Cloud system 100 also preferably includes one or more cloud APIs 103 (Application Programming Interfaces) enabling communication with message broker service 101. Cloud API 103 serves as an interface to other exemplary components of management system 102. This includes: CMS core 104, which preferably is a web-based content management system enabling uses to access, view, store, modify and control data and files relating to devices including Gateways and Nodes and other systems accessible over a network coupled to the CMS, etc.; active service 105 (e.g., Javascript, which maintains latest data base and settings even if the user's network connection fails or the user is offline); database system 107; storage system 106; and web UX 108.

Web UX 108 (UX an acronym for User Experience) provides a user interface (UI) to cloud system 100, which preferably is connected to one or more user endpoint/application 115 over connection 124. Connection 124 may be any suitable connection(s) between a user endpoint/application 115, which may be a wired or wireless Internet connection or other connection to the user interface of web UX 108. What is important is that users have a system for interfacing with management system 102. User end point/application 115, in an exemplary configuration, includes: web API 116 coupled to web browser 117 (which may be a browser on a personal computer, laptop or mobile device such as a cellphone or tablet); API 118 (preferably for a mobile operating system such as Apple's iOS or Google's Android operating systems) coupled to smart phone 119 (or tablet), which can provide an application on the mobile devices that can interface with the user interface of web UX 108; API 120 (preferably for an embedded device) coupled to unit 121, which may be, for example, an in-home display unit, an intelligent personal assistant service such as Siri on an iOS device or Google Now on an Android device, or IFTTT (If This Then That) web service. User end point/application 115 also may communication messages to/from management system 102 via message broker service 101 over connection 103, as illustrated. What is important is that users may communication messages between user end point/application 115 and management system 102, and/or that user end point/application 115 provides a user application/service so that users can interact with management system 102 via the user interface of web UX 108. As will understood, connection 123 and 124 may be separate communication connections, or may be over a common network connection.

In accordance with certain preferred embodiments, user end point/application 115 provides a device and/or service for cataloging and registering Gateways and Nodes into a network such as WSN 110.

WSN 110 is one or more networks of sensors and/or other devices (Nodes) capable of sending and receiving data or other electrical signals to/from cloud system 100 over connection 122. In general, WSN 110 includes one or more units capable of communication with cloud system 100 via connection 122, and in general such units are illustrated by Gateway 111. While WSN 110 is illustrated with one Gateway 111, WSNs may include more than one Gateway 111 providing a connection to cloud system 100. WSN 110 also includes a plurality of Nodes 112, which may include a few or even hundreds or thousands of Nodes that connect to each other (as illustrated by the lines connecting nodes 112 in WSN 110, which preferably are wireless/radio connections), and which in a networked manner connect to gateway 111, which may then communicate with cloud system 100 over connection 122. In such a manner, a plurality of Nodes (which may be lower in cost, battery operated, etc.) may wirelessly connect with each other and directly or indirectly to Gateway 111 for communication with cloud system 100. Connection 122 may be, for example, an Internet connection provided in any desired manner, which may be by WiFi, cellular (2G, 3G, 4G, LTE, etc.), Ethernet, etc. What is important is that WSN 110 communicates with a plurality of Nodes 112 over a network connection 122 via one or more Gateways 111.

FIG. 1B illustrates an exemplary configuration of Gateway 111 (the present invention is not limited to this particular configuration). Exemplary Gateway 111 utilizes, for example, an NXP Semiconductor JN5168 wireless microcontroller, the data sheets and user manuals for which are hereby incorporated by reference. In other embodiments, other microcontrollers are utilized in Gateway 111.

As illustrated in FIG. 1B, exemplary Gateway 111 includes processor 130, which is powered by power regulator and distributor 131, receiving power from battery/power source 132. In preferred embodiments, battery/power source 132 is a battery providing the capability of Gateway 111 to be de-coupled from a wired power source, although in alternative embodiments (such as a power meter) Gateway 111 may receive electrical power via physical wires from a power source or electrical grid. Processor 130 is coupled to and can exchange data with EEPROM 133, ROM/Code Flash 134 and RAM 135, which are provided in Gateway 111 to provide sufficient data storage for gateway 111 to carry out its desired operations and functions. Processor 130 preferably exchanges data with exemplary radio MAC+physical layer 136, which as will be appreciated by those of skill in the art, provides a media access controller (MAC) and physical layer interface with a radio in Gateway 111 (as is known in the art, a MAC address is a unique identifier assigned by the hardware manufacturer to network interfaces for communications on a network). Although not shown in FIG. 1B, Gateway 111 may include an antenna coupled to MAC+physical layer 136 in order to radiate RF signals to nodes 112. What is important is that Gateway 111 includes circuitry and physical structure to provide an RF emitting capability for wirelessly communicating with nodes 112.

Also as illustrated in FIG. 1B, processor 130 couples data to/from interface circuit 137, preferably implements one or more GPIO/SPI/I2C peripheral interfaces so that Gateway 111 can communicate with network connection module 139, which provides network connectivity so that Gateway 111 can communicate with cloud system 140. This preferably is by way of messages processed by message broker/management system 141 as illustrated, and as an example cloud system 140 and message broker/management system 141 may be implemented as cloud system 100, message broker service 101 and management system 102, as discussed in connection with FIG. 1A. As illustrated in FIG. 1B, network connection 139 may be wired Ethernet (e.g., 802.3), wireless Ethernet or WiFi (e.g., 802.11), or cellular (2G, 3G, 4G, LTE, etc.) or other network connection. What is important is that Gateway 111 include internally or be coupled to a communication module such as network connection module 139 so that Gateway 111 has a network connection so that it can communicate to the Internet and a cloud system such as cloud system 140, 100.

Block 142 of FIG. 1B illustrates exemplary services/functions provided by software executed by processor 130 in conjunction with various other elements of Gateway 111 in accordance with embodiments of the present invention. Exemplary services/functions provided by processor 130 include: Core and base operations and APIs for gateway 111; OND (Over Network Download/Over Internet Download); OAD (Over Air Download); Logging functions; Control/Sensing/Monitoring functions; Binding functions (e.g., to particular nodes or gateways); Grouping (for group control, messaging, etc.); Recovery; Troubleshooting (software routines for diagnosing and/or resolving errors or problems]; NTP (Network Time Protocol); UPnP (Universal Plug n Play); SSL (Secure Sockets Layer); Web Socket; MQTT (MQ Telemetry Transport); REST (Representational State Transfer API); DTLS (Datagram Transport Layer Security); Messaging; IPv4; IPv6; RPL (IPv6 Routing Protocol for Low power and Lossy Networks); and 802.15.4 API.

Additional information regarding certain of such exemplary services/functions illustrated in FIG. 1B is as follows.

OND (Over Network Download/Over Internet Download); Gateway preferably is provided via the cloud a URL of a firmware update image to download. In the Gateway, preferably one process is invoked. The updated firmware image preferably is downloaded and stored in Flash. This firmware preferably has special bytes embedded in the firmware image, which can include firmware version, device type and MD5, and preferably data for confirming the authenticity and compatibility of the updated firmware before the update is applied.

OAD (Over Air Download); for Node firmware updates preferably this update service/block is added. In the Gateway, an updated firmware image for the Node is obtained via OND. As we there typically is a limitation on the RF payload length, in preferred embodiments the following mechanism is implemented. Nodes to be updated request blocks of updated firmware image from the Gateway. The Gateway preferably will reply with a specific block to a specific Node. For traffic reduction and fast updates, preferably there is a block preserving functionality, and there may be at least two different methods for OAD: N to N update (single), or N to Many update (more than one). This firmware also preferably has some special bytes embedded in the firmware image, which may include firmware version, device type and MD5, and preferably data for confirming the authenticity and compatibility of the updated firmware before the update is applied.

Binding; you can bind two different devices such as for making an action trigger mechanism (e.g., If This event Then That action, such as binding of a temperature sensor with a fan control); preferably Binding MIB is provided and the user can easily set binding rules; as is known in the art, a management information base (MIB) is a formal description of a set of network objects that can be managed using the Simple Network Management Protocol (SNMP), and the format of the MIB may be defined as part of the SNMP protocol.

Grouping; for group control or group binding.

Recovery; preferably, on power failure, or any network failure, the Gateway or Node will recover itself. Also, preferably a log is provided of network failure events and status, etc.

Messaging; preferably, a compact, efficient messaging service is provided, with a communication protocol for Nodes, Gateways and the cloud. A custom protocol (such as AIMs developed by Applicant) or a standard protocol like CoAP (Constrained Application Protocol), MQTT, JSON (JavaScript Object Notation) are used in preferred and alternative embodiments.

What should be appreciated is that Gateway 111 has hardware and software resources to carry out services and functions for communicating with a plurality of Nodes 112 (for control thereof, and communicating data to and from Nodes 112), and also communicate messages to/from cloud system 100.

Each Gateway 111 and each Node 112 preferably have associated therewith a network address, which preferably is an IP address. In preferred embodiments, IPv6 addresses are used for Gateways and Nodes. In preferred embodiments, each Gateway will be provided with a prefix that is provided from an Internet Service Provider (ISP) that will provide Internet access for the Gateway. Preferably, the Gateway forms an IPv6 address based on (prefix::<MAC>), which will be that Gateway's IPv6 address. When a Node has not yet been registered as part of a network, it preferably will self assign an IPv6 address using a link local address based on (fe80::<MAC>). When a Node is registered and becomes part of a network, it preferably will be provided a prefix from the Gateway (typically the same prefix as provided from the ISP) and the Node will create a IPv6 address from that prefix based on (prefix::<MAC>). Other IPv6 type address generation schemes may be used in alternative embodiments. As for communication with Nodes, in preferred embodiments Gateways preferably may use IPv6 unicast messages based on (aaaa::<MAC>), IPv6 anycast messages based on (ff02::<anycast_IP>), and IPv6 multicast messages based on (ff00::<multicast_IP>). Such IPv6 messaging and addressing techniques will be understood in the context of the present invention by those of skill in the art.

FIG. 1C illustrates an exemplary configuration of Node 112. Exemplary Node 112 utilizes, for example, an NXP Semiconductor JN5168 wireless microcontroller, the data sheets and user manuals for which are hereby incorporated by reference. In other embodiments, other microcontrollers are utilized in Nodes 112. As will be understood by those of skill in the art, WSN110 could have a Nodes and Gateways using a variety of microcontrollers, provided that the Nodes and Gateways operate and communicate in a manner consistent with other Nodes and Gateways.

In certain preferred embodiments, Gateway 111 and Nodes 112 are implemented with common components/functions, as will be appreciated from a comparison of FIG. 1B with FIG. 1C, and an understanding of such common components/functions may be understood based on the discussion provided with respect to Gateway 111 and FIG. 1B. Similarly, Block 138 of node 112 illustrates exemplary services/functions provided by software executed by processor 130 in conjunction with various other elements of node 112. Such exemplary services/functions in general may be a subset of services/functions of gateway 111 discussed in conjunction with FIG. 1B and may be understood based on the previous discussion.

What should be appreciated is that Nodes 112 have hardware and software resources to carry out services and functions for communicating with other of Nodes 112 (for passing messages for control thereof, and communicating data to and from Nodes 112), and also communicate messages to/from Gateway 111. As will be appreciated from description elsewhere herein, in preferred embodiments such communications preferably are based on IPv6-based network communications, which may be over the Internet.

In a preferred embodiment of the present invention, nodes and gateways in a network utilize a mechanism for parent selection that is improved by adding the LQI to the ranking method. As per the IEEE 802.15.4 specification, the LQI is available when any packet is received at the PHY layer.

In the preferred Rank determination method, when a DIO is received from a neighbor node, its LQI is updated in the candidate parent table. This preferably is done using a weighted moving average of the LQI for the neighbor node. For example:

Parent→Link Metric=base*(Parent→Link Metric)+(1−base)*LQI

In the above equation, base is the weighting factor for the historical Link Metric for that component. For example, if 90% weighting is given to the historical average of the Link Metric, then base is equal to 90%, and the above equation will be:

Parent→Link Metric=0.9*(Parent→Link Metric)+(1−0.9)*LQI

A threshold minimum Link Metric preferably is selected to reduce the possibility that a weak signal in the total absence of noise may give a false low LQI. Nodes in the candidate parent table that have a Link Metric that is above the threshold are compared. Whichever node has the lower rank will be set as the preferred parent.

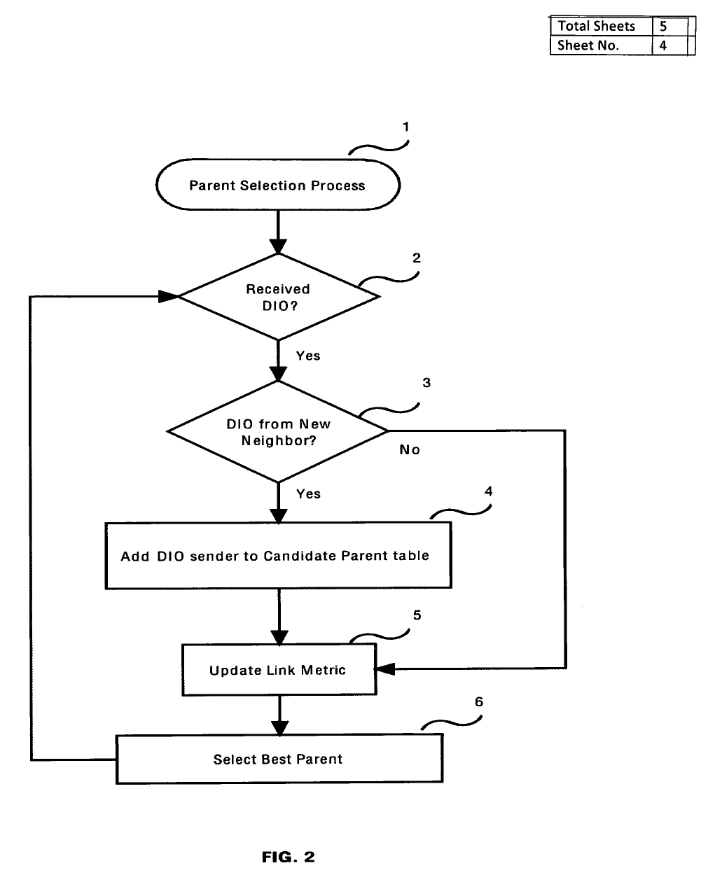

FIG. 2 is a diagram of the Parent Selection Process, which in preferred embodiments is the method by which each node finds its Best Parent in the network. In current RPL practice, this is done by comparing available candidate parents using multiple parameters, such as path ETX, Hop count, etc., then calculating a Rank on the basis of these parameters, and choosing the parent which has the minimum Rank. Reference is made to the description of Rank and Rank calculation set forth above, which also is used in embodiments of the present invention. This Rank calculation process is done each time a node receives a DIO. In the present invention, in addition to performing a Rank calculation, a weighted LQI preferably is also used to refine parent selection.

In the Parent Selection Process, nodes are waiting to receive a DIO in step 1. In step 2, a DIO is received. In step 3 it is determined whether the DIO is from an existing candidate parent node or from a new neighbor node.

If the DIO is from a neighbor that is not in the candidate parent table, then in step 4 the neighbor is added to the candidate parent table. In step 5, the LQI metrics for the new neighbor node, which are calculated when the DIO is received, are also added. If the DIO is from a neighbor that is already in the candidate parent table, then in step 5 the LQI metrics for the existing node are also updated. In the preferred embodiment, the parent link metrics are updated with the weighted moving average of LQI.

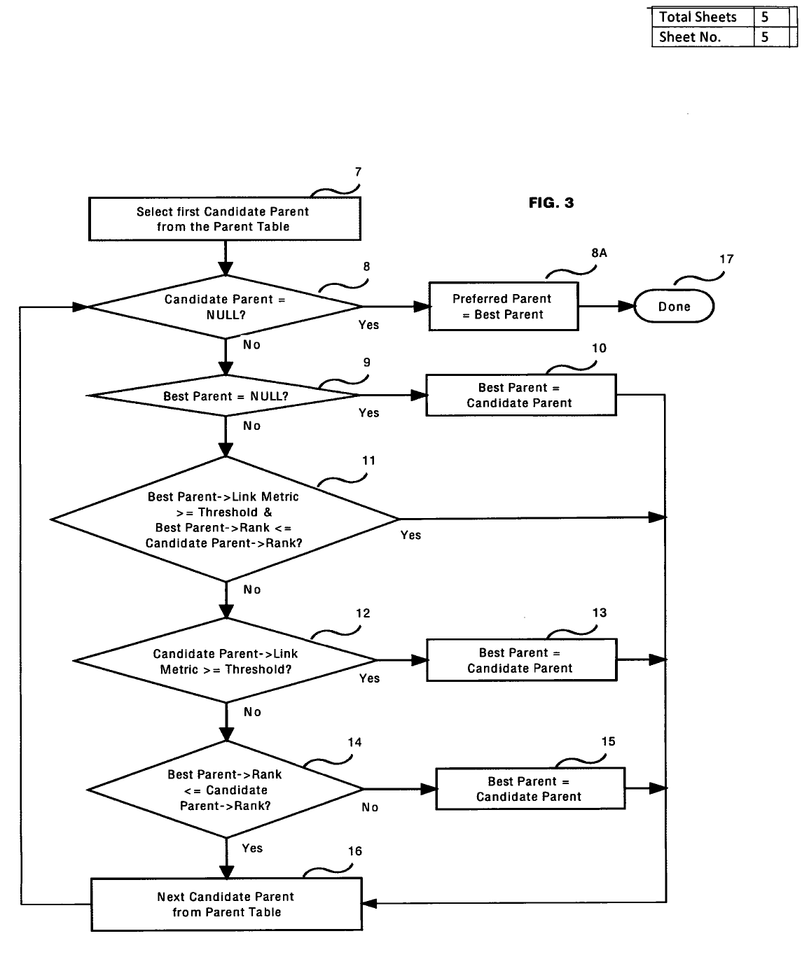

After the candidate parent table is fully updated with new neighbors and LQI metrics, in step 6 the Best Parent is selected from those in the candidate parent table. This process is outlined in FIG. 3.

In step 7 of FIG. 3, the first entry in the candidate parent table is selected. In step 8, this candidate parent is compared to NULL. In the first iteration of this process, the selected parent will not be NULL (NULL indicating that all candidate parents have been selected, and no candidate parents are left to be compared, etc.), so the process continues to step 9.

In step 9, if the Best Parent is NULL (no Best Parent), then Best Parent is set to the candidate parent in step 10. In step 16 the next candidate parent is selected and the procedure is repeated from steps 8 to 16. In step 9, if the Best Parent is not NULL, the process moves to step 11.

In step 11, if the Best Parent has a Link Metric greater or equal to the threshold and also Best Parent Rank is less than or equal to the Rank of the candidate parent, then the Best Parent remains unchanged and the process continues with the selection of the next candidate parent in step 16. The procedure then is repeated from steps 8 to 16. If in step 11 the Best Parent has a Link Metric that is less than the threshold or a Rank greater than the candidate parent, the process continues with step 12.

In step 12, if the candidate parent Link Metric is greater than or equal to the threshold, then in step 13 the Best Parent is replaced with the candidate parent. The next candidate parent is selected in step 16, and the procedure then is repeated from steps 8 to 16. If in step 12 the candidate parent Link Metric is less than the threshold, the process continues with step 14.

In step 14, if the Best Parent Rank is less than or equal to the candidate parent Rank, then the Best Parent remains unchanged and the process continues with the selection of the next candidate parent in step 16. The procedure then is repeated from steps 8 to 16. If in step 14 the Best Parent Rank is greater than the candidate parent Rank, then in step 15 the Best Parent is replaced with the candidate parent. The next candidate parent is selected in step 16, and the procedure then is repeated from steps 8 to 16.

The Best Parent selection process ends when step 16 selects a NULL value, indicating there are no more candidate parents in the table. The process continues to step 8, where the NULL value for Parent causes the Preferred Parent to be set to the Best Parent in step 8A. The process then completes in step 17.

In accordance with the present invention, parent selection improves network stability by incorporating a link metric that is compared with a threshold before a parent selection is changed, preferably in combination with comparison of parent rank. As will be appreciated from the foregoing description, in accordance with embodiments of the present invention a weighted LQI parameter, and an LQI threshold, preferably are given a higher priority than a Rank comparison, and also preferably a higher priority than hop count of surrounding neighbors, or errors in transmission rate.

In accordance with the present invention, network stability, particularly at the edges of the network, is increased based on improved parent selection capabilities as disclosed herein.

Although the invention has been described in conjunction with specific preferred and other embodiments, it is evident that many substitutions, alternatives and variations will be apparent to those skilled in the art in light of the foregoing description. Accordingly, the invention is intended to embrace all of the alternatives and variations that fall within the spirit and scope of the appended claims. For example, it should be understood that, in accordance with the various alternative embodiments described herein, various systems, and uses and methods based on such systems, may be obtained. The various refinements and alternative and additional features also described may be combined to provide additional advantageous combinations and the like in accordance with the present invention. Also as will be understood by those skilled in the art based on the foregoing description, various aspects of the preferred embodiments may be used in various subcombinations to achieve at least certain of the benefits and attributes described herein, and such subcombinations also are within the scope of the present invention. All such refinements, enhancements and further uses of the present invention are within the scope of the present invention.

What is claimed is:

1. A wireless sensor network (WSN) comprising:
a content management system (CMS) communicating over a network connection, wherein the CMS operates with a registration service;
at least one gateway in data communication with the CMS via the network connection, wherein the gateway is selectively registered as part of the WSN via operation of the registration service, wherein the gateway includes a radio transceiver for communication with nodes of the WSN;
a plurality of nodes coupled to the gateway, wherein each of the nodes has a radio transceiver for communication with the gateway;
wherein each node determines a parent node based on a Link Quality Indicator (LQI) parameter and a Rank calculation.

2. The network of claim 1, wherein the LQI parameter comprises a weighted average of LQI values.

3. The network of claim 2, wherein the LQI values are determined upon receipt of a DIO message from an adjacent node.

4. The network of claim 2, wherein the LQI value comprises an 802.15.4 physical layer metric.

5. The network of claim 2, wherein each node periodically determines a parent based on receipt of DIO messages from a plurality of nodes.

6. The network of claim 1, wherein a node is not considered a candidate parent node unless the LQI parameter for the node exceeds a threshold LQI value.

7. The network of claim 1, wherein the LQI parameter is given a higher priority as compared to the Rank calculation.
